(19) United States
(12) Patent Application Publication
(10) Pub. No.: US 2012/0106425 A1
(43) Pub. Date: May 3, 2012

(54) Managing Multicast Membership in Wireless LANS

(76) Inventor: Ramsundar Janakiraman, Sunnyvale, CA (US)

(21) Appl. No.: 12/916,273

(22) Filed: Oct. 29, 2010

(51) Int. Cl. H04H 20/71

(52) U.S. Cl. 370/312

(57) ABSTRACT

Processing of IGMP control packets in an access point (AP) connected to a digital network. According to the present invention, an AP in a network converts IGMP queries from multicast to unicast and sends these unicast packets to each client of the AP. These IGMP query packets may be filtered or restricted by per-user client rules These IGMP query packets may also be tagged as high priority packets to speed their delivery. The AP also suppresses the retransmission of IGMP Join packets to clients of the AP.

### BACKGROUND OF THE INVENTION

The present invention relates to digital networks, and in particular, to delivering and managing multicast traffic over wireless local area networks.

Digital networks have rapidly become the backbone of many enterprises, small and large. Such networks are used for handling many different kinds of traffic. One type of traffic becoming increasingly important is Multicast traffic, which is used to carry media streams such as video, among others.

Multicast by definition is traffic sent from one source to multiple destinations. As an example, if twenty users subscribe to the same video stream, only one multicast stream is transmitted from a media server through the network to multiple destination, rather than twenty separate unicast streams.

Protocols such as IGMP are known in the art for managing multicast membership on networks. IGMP protocols rely upon reliable delivery of the underlying multicast packets.

Wireless networks, and multicast distribution over wireless networks such as wireless local area networks (WLANs) introduce a host of new problems to multicast distribution. On the wired network, all packets travel at the same speed, and the CSMA/CD nature of wired Ethernet networks carries with it a high degree of reliability. On WLANs, however, multicast packets are sent at much lower data rates, in comparison to unicast packets, to help insure delivery. Multicast packets are also sent using UDP, a connectionless protocol, with limited error recovery mechanisms.

Many WLAN systems deliver multicast traffic over WLANs by converting the multicast packets to unicast at Level 2, such as at an access point(AP). While this allows the converted multicast packets to be transmitted at much higher data rates, issues still exist with respect to IGMP control-plane traffic such as Joins and Queries.

Inconsistent IGMP group membership, as an example, results in multicast to unicast conversions not happening for interested clients, or wasted bandwidth in sending multicast streams to clients that are not interested in the multicast group.

What is needed is a way to improve handling of IGMP membership protocols in wireless portions of a network.

### BRIEF DESCRIPTION OF THE DRAWINGS

The invention may be best understood by referring to the following description and accompanying drawings that are used to illustrate embodiments of the invention in which:

FIG. 1 shows clients in a network.

### DETAILED DESCRIPTION

Embodiments of the invention relate to methods of handling IGMP protocol packets by controllers and/or wireless access points (APs) in a digital network.

According to the present invention, a device in a network such as a controller or an AP converts permitted IGMP queries from multicast to unicast and sends these unicast packets to each client of the device. These query packets may be filtered or restricted by per-user client rules These query packets may also be tagged as high priority packets to speed their delivery. The device also suppresses the retransmission of IGMP Join packets to clients of the device.

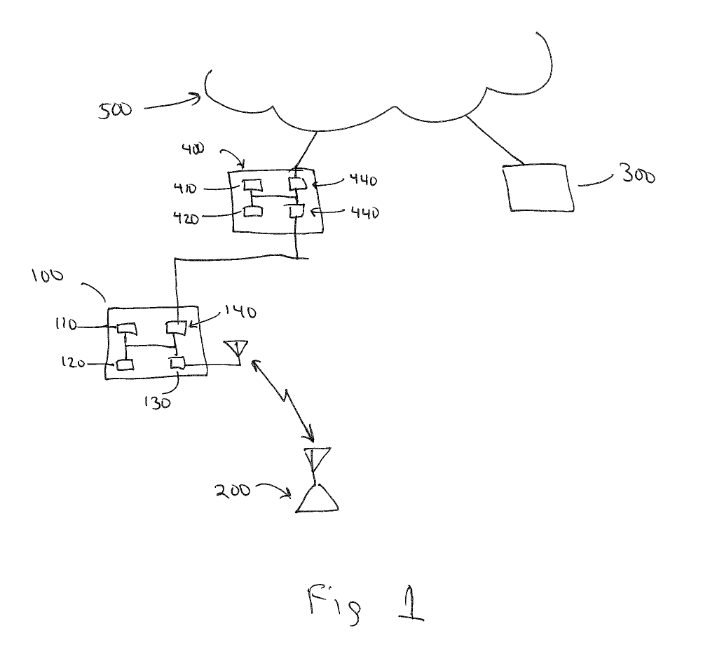

FIG. 1 shows a network in which access points (APs) 100 are purpose-made digital devices, each containing a processor 110, memory hierarchy 120, and input-output interfaces 130. In one embodiment of the invention, a MIPS-class processor such as those from Cavium or RMI is used. Other suitable processors, such as those from Intel or AMD may also be used. The memory hierarchy 120 traditionally comprises fast read/write memory for holding processor data and instructions while operating, and nonvolatile memory such as EEPROM and/or Flash for storing files and system startup information. Wired interfaces 140 are typically IEEE 802.3 Ethernet interfaces, used for wired connections to other network devices such as switches, or to a controller. Wireless interfaces 130 may be WiMAX, 3G, 4G, and/or IEEE 802.11 wireless interfaces. In one embodiment of the invention, APs operate under control of a LINUX operating system, with purpose-built programs providing host controller and access point functionality. Access points 100 typically communicate with a controller 400, which is also a purpose-built digital device having a processor 410, memory hierarchy 420, and commonly a plurality of wired interfaces 440. Controller 400 provides access to network 500, which may be a private intranet or the public internet.

Note that while the present invention is described in terms of an access point (AP), the required functionality may be embodied in a combined controller/AP.

Client devices 200 have similar architectures, chiefly differing in input/output devices; a laptop computer will usually contain a large LCD, while a handheld wireless scanner will typically have a much smaller display, but contain a laser barcode scanner.

According to the present invention, an access point 100 passes traffic to and from clients 200 to other services such as controller 400 and services present on network 500.

It is important to note that according to WLAN standards, such as IEEE 802.11 standards, unicast packets are always acknowledged by the receiver, and retransmitted when errors in delivery are detected, while multicast packets are not acknowledged, and are sent at very low data rates to increase the probability of reliable reception by multiple clients. As an example, multicast packets are sent at a 24 Mbps rate, while unicast packets sent on the same IEEE 802.11 n network will be sent at 300 Mbps.

It is known in the art to convert multicast data packets to unicast at the wireless access point. Depending on the number of subscribers for a particular multicast stream, it may take less air time to transmit one unicast packet at, for example, the 11n data rate of 300 Mbs to each subscriber to the multicast stream than to transmit one multicast packet at the much slower 24 MBs 802.11 b data rate.

According to the present invention, AP 100 deals with IGMP membership control packets such as IGMP queries and IGMP joins. By definition, an AP 100 has a list of all client devices 200 associated with the AP.

According to the present invention, when AP 100 receives an IGMP query from an upstream source such as multimedia server 300 or controller 100, it converts that IGMP query from multicast to unicast form, and transmits an IGMP V2 query to all clients 200 of AP 100. In different embodiments, such upstream IGMP queries may be subject to per-client firewall rules or filtering. As an example, rules associated with some clients may not permit multicast traffic, or may limit multicast traffic. Optionally, when the IGMP query is converted from multicast to unicast, it may be tagged as a high-priority packet to speed the delivery of the unicast IGMP query to AP clients 200.

Forwarding the IGMP query as an IGMPv2 query forces clients to switch to IGMPv2. Use of IGMPv2 allows in particular upstream switches reliant on older IGMPv2 protocols to successfully collect downstream membership information.

As is known to the art, client devices 200 on reception of an IGMP query for a stream the client is interested in will respond with an IGMP join. These IGMP join responses, which are multicast, are typically flooded to all L2 clients, those client devices associated to the same SSID on the AP to which the client is associated. This query/response flooding may occupy significant airtime if a large number of client devices 200 are involved. Suppressing the local flooding of these local IGMP join responses saves airtime.

Another issue with flooding of IGMP joins is that some clients 200 will suppress their own join response if they see another join response for the same multicast stream. While such behavior may be beneficial in reducing air time, it also results in hidden clients, such that AP 100 does not have an accurate list of clients for the multicast streams it is handling.

According to the present invention, when AP 100 receives an IGMP join from a client 200, this IGMP join is forwarded upstream, but is not flooded back to all clients of AP 100. This forces all interested clients 200 to send individual IGMP join responses, resulting in accurate membership information held by AP 100.

Optionally, when AP 100 forwards IGMP Queries from an upstream node such as multimedia server 300 to a client 200 of AP 100, the AP converts this packet to a unicast packet containing an IGMPv2 formatted query, with a short response time, for example 100 ms. Directing this unicast query directly to the client triggers the client to reply with IGMP joins for all interested multicast groups. These IGMP joins are forwarded upstream by AP 100. Since the IGMP Query was converted to an IGMPv2 Query, the responding Join will also be IGMPv2. Thus, even if the Query originated by multimedia server is IGMPv3, the Join replies will be IGMPv2, allowing any switches and/or controllers, such as controller 400, to successfully snoop older IGMPv2 control packets.

The present invention may be realized in hardware, software, or a combination of hardware and software. The present invention may be realized in a centralized fashion in one computer system such as AP 100, or in a distributed fashion where different elements are spread across several interconnected computer systems. A typical combination of hardware and software may be a controller or access point with a computer program that, when being loaded and executed, controls the device such that it carries out the methods described herein.

The present invention also may be embedded in nontransitory fashion in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

I claim:

1. A method of handling IGMP traffic in an access point (AP) connected to a digital network comprising:
detecting an IGMP Query directed to a client of the AP,
converting the IGMP Query from multicast to unicast form, and
sending the converted IGMP Query to the client as a unicast packet.

2. The method of claim 1 where the step of converting the IGMP Query from multicast to unicast form includes the step of converting the IGMP Query to an IGMPv2 Query.

3. The method of claim 1 further comprising the step of marking the converted IGMP Query as high priority prior to sending the converted IGMP Query.

4. The method of claim 1 further comprising applying per-client filtering rules to the detected IGMP Queries and only processing the Query if allowed by the filtering rules.

5. The method of claim 1 further comprising suppressing the local flooding of IGMP Joins sent by the client in response to the IGMP Query.

6. A machine readable medium having a set of instructions stored in nonvolatile form therein, which when executed on an access point (AP) causes a set of operations to be performed comprising:
detecting an IGMP Query directed to a client of the AP,
converting the IGMP Query from multicast to unicast form,
sending the converted IGMP Query to the client as a unicast packet, and,
suppressing the local flooding of IGMP Joins sent by the client in response to the IGMP Query.

7. The machine readable medium of claim 6 where the step of converting the IGMP Query from multicast to unicast form includes the step of converting the IGMP Query to an IGMPv2 Query.

8. The machine readable medium of claim 6 further comprising the step of marking the converted IGMP Query as high priority prior to sending the converted IGMP Query.

9. The machine readable medium of claim 6 further comprising applying per-client filtering rules to the detected IGMP Queries and only processing the Query if allowed by the filtering rules.
